(19) United States
(12) Patent Application Publication
(10) Pub. No.: US 2010/0299925 A1
(43) Pub. Date: Dec. 2, 2010

(54) METHOD FOR FORMING A GEAR

(76) Inventors: Chih-Hao LIN, Pingtung County (TW); Tseng-Jen Cheng, Kaohsiung County (TW); Yu-Ting Lin, Kaohsiuing City (TW)

Correspondence Address: Muncy, Geissler, Olds & Lowe, PLLC, 4000 Legato Road, Suite 310, FAIRFAX, VA, 22033, US

(21) Appl. No.: 12/787,849

(22) Filed: May 26, 2010

(30) Foreign Application Priority Data
May 27, 2009 (TW) 098117680

(51) Int. Cl. B23P 15/14; F16H 55/17

(52) U.S. Cl. 29/893.34; 74/434

(57) ABSTRACT

A method for forming a gear, including the following steps: first obtaining a billet, then carrying out a backward extrusion process of the billet to form a forged billet with a blind hole by using a mold, and the forged billet has an appropriate axial length and an appropriate radial length. Then, a precise piercing process is carried out to remove the solid billet portion remained in the blind hole of the forged billet to form a through hole. Then, trimming of the through hole is carried out to form a high-precision inner hole, and positioning is carried out based on the high-precision inner hole to implement a pressing process of an outer tooth shape of the forged billet to form the gear.

This application claims the benefit of Taiwan Patent Application No. 098117680, filed on May 27, 2009, which is hereby incorporated by reference for all purposes as if fully set forth herein.

### BACKGROUND OF THE INVENTION

1. Field of the Invention

The present invention relates to a method for forming a gear, and more particularly relates to a method for forming a gear, wherein the method adopts exhaustive progressive cold forging.

2. Description of the Prior Art

Referring to FIG. 1A, which depicts a flow chart of a conventional hot forging method for forming a gear, and generally conventional gear forming methods use hot forging forming methods, all of which heat a rod-shaped billet to above the recrystallization temperature as the first step in the manufacturing flow, and then upsetting is carried out to obtain the required billet length. After which, sandblasting and machining steps are carried out to form the gear. However, the major shortcoming of the aforementioned hot forging forming method lies in that in the gear forming process, the billet (such as rod-shaped material) is heated to above the recrystallization temperature which often results in separation of the oxidized scale and causes surface decarburization after the gear is formed, such that the dimensional precision and the surface roughness of the final gear are hard to be controlled and may exceed the acceptable tolerances, resulting in that precision is too poor to be used in the manufacture of micro-gears.

On the other hand, in recent years, a cold forging finishing method is adopted in the final stage of the gear forming methods for the portions requiring a high precision in dimension. However, although the hybrid way of hot and cold forgings can increase the precision of micro-gears in dimension, the oxidized scale and the surface decarburization layer portions caused by the hot forging are required to be processed in advance, thereby increasing time-consuming.

Referring to FIG. 1B, which depicts a flow chart of a conventional cold-hot forging method for forming a gear, in which a rod-shaped billet is first heated to above the recrystallization temperature, and then upsetting is carried out to obtain the required billet length. After which, trimming, cold forge resizing and coining steps are carried out to form the gear. Conventional gear forming methods use a one-process cold forging method to form a gear. With regard to the desire to develop micro-gears (having a modulus below 1, and number of teeth of around 13 to 20), because of the work hardening easily formed during instantaneous cold forging, thus, an enormous deformation resistance load is produced, resulting in it being difficult to form micro-gears, even causing die-punch fractures.

### SUMMARY OF THE INVENTION

In order to resolve the aforementioned problems, the present invention provides an exhaustive progressive cold forging forming method, and uses a multi-processes volume distribution design, reducing the load step by step to complete formation of a gear by the forging process.

A method for forming a gear of the present invention for resolving the aforementioned problems comprises: carrying out a backward extrusion process of a billet to form a forged billet with a blind hole by using a mold, wherein the forged billet being formed with an appropriate axial length and an appropriate radial length; carrying out a precise piercing process of the forged billet to remove a solid billet portion remained in the blind hole of the forged billet so as to form a through hole; as well as carrying out a positioning process of the forged billet based on the through hole, so as to implement a pressing process of an outer tooth shape of the forged billet, thereby forming a gear.

In the method for forming a gear, before the step of carrying out the backward extrusion process, the method further comprises sizing a locating hole in axial end surfaces vertical to the billet.

In the method for forming a gear, at the same time or after the step of carrying out the precise piercing process, trimming of the through hole of the forged billet is carried out to form a high-precision inner hole with preferred real roundness and surface roughness.

In the method for forming a gear, a thickness of the solid billet portion remained in the blind hole is less than or equal to the piercing thickness of the forged billet when carrying out the precise piercing process.

In the method for forming a gear, the gear is a micro-gear and the micro-gear may be a spur gear, and the steps in the method define an exhaustive progressive cold forging.

The present invention is characterized in that the manufacturing process of the present invention uses an exhaustive progressive cold forging forming method, in which a refined horizontal forging machine is primarily utilized for progressive operation to produce a large quantity of gear within a short period of time, thereby providing a huge advantage to the manufacturing process technology. The principle of the present invention is to change the original single-process cold upsetting forming method of the prior art to a six-processes gear forming method the present invention, because the enormous load in the original single-process cold upsetting forming method causes the mold to collapse (predominantly punch fractures). The gear forming method the present invention uses the first five processes to design volume distribution to reduce the load step by step before carrying out the final formation of the gear, and complete pre-forging and pre-forming of the gear. Finally, in the sixth process, the gear is formed within certain machine equipment specifications (total processes are predominantly within six processes).

As described above, in the manufacturing process of the present invention, the load is reduced after passing multi-processes, which also substantially reduce the loading of the mold during formation and the chances of mold collapse as well. Besides, it can also increase the number of times the mold used in mass production (the lifetime of mold is prolonged), thereby substantially reducing production costs, and increasing yield rate.

The precision of conventional hot forging process is often affected by an oxidized skin scale layer and a surface decarburization layer, thus substantial manpower is required in the latter high-precision cutting process. However, the manufacturing process of the present invention eliminates the conventional hot forging process, such that not only processing costs but also material waste can be reduced.

The manufacturing process of the present invention eliminates the conventional hot-cold gear forging method, in which a cold forging finishing method is adopted to replace traditional high-precision cutting post-processing because of poor precision of hot forging methods. In addition, the manufacturing process of the present invention is also able to reduce mold change time required for hot-cold forging, and may complete formation of the gear by a single cold forging operation, thus, processing time and cost can be substantially reduced.

The present invention first carries out forming a high-precision inner hole, takes the inner hole as a criterion, and uses pressing process to form an outer tooth shape, thereby enabling inner hole precision when the gear is configured and the configuration precision when the gear is assembled to achieve a precision within the required tolerance, and increasing transmission effectiveness of the gear.

The micro-gear progressive cold forming method used in the present invention is provided with many characteristics, including: high precision, enabling avoid dimensional error caused by the hot forging; reducing miscellaneous processing and mold matching during the process of hot forging to cold forging; uses multi-processes forming load distribution to break through the bottleneck of forming micro-gears by using cold forging; by adopting an exhaustive cold forming method, the material easily adapts to strain conditions, resulting in better mechanical strength, and thereby enabling the lifetime of the gears to be substantially increased.

To enable a further understanding of the objectives and the technological methods of the invention herein, a brief description of the drawings is provided below followed by a detailed description of the preferred embodiments.

### BRIEF DESCRIPTION OF THE DRAWINGS

FIG. 1A is a flow chart of a conventional hot forging method for forming a gear.

FIG. 1B is a flow chart of a conventional cold-hot forging method for forming a gear.

FIG. 2 is a flow chart depicting a gear progressive cold forging forming method according to an embodiment of the present invention.

FIG. 3A is a schematic structural view of a billet according to an embodiment of the present invention.

FIG. 3B to FIG. 3C are schematic structural views depicting sizing locating holes step according to an embodiment of the present invention.

FIG. 3D is a schematic structural view depicting implementation of a backward extrusion process of a billet to form a forged billet according to an embodiment of the present invention.

FIG. 3E is a schematic structural view depicting implementation of a precise piercing process according to an embodiment of the present invention.

FIG. 3F is a structural view depicting trimming of a through hole to form a high-precision inner hole according to an embodiment of the present invention.

FIG. 3G is a schematic structural view depicting implementation of a pressing process to form an outer tooth shape of the forged billet according to an embodiment of the present invention.

FIG. 3H is a front cutaway view of FIG. 3G

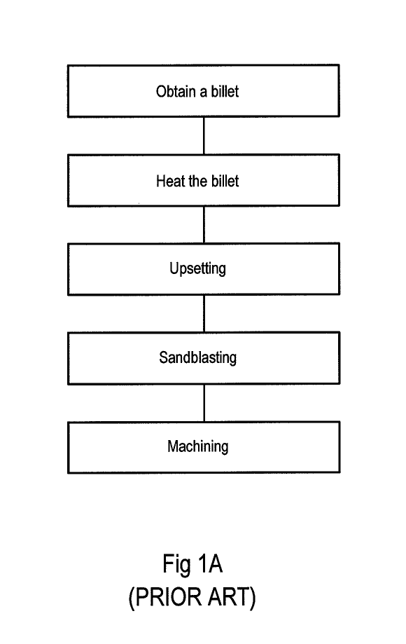

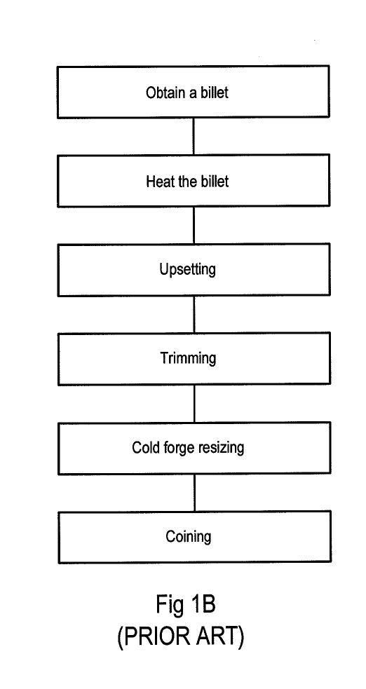

### DETAILED DESCRIPTION OF THE PREFERRED EMBODIMENTS

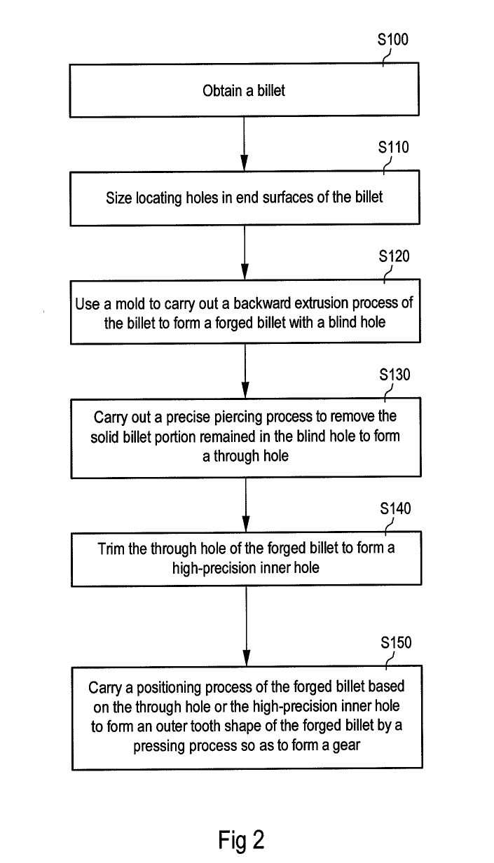

Referring first to FIG. 2, which shows a flow chart depicting a gear progressive cold forging forming method according to an embodiment of the present invention, and steps in the formation of the gear comprise steps as follows:

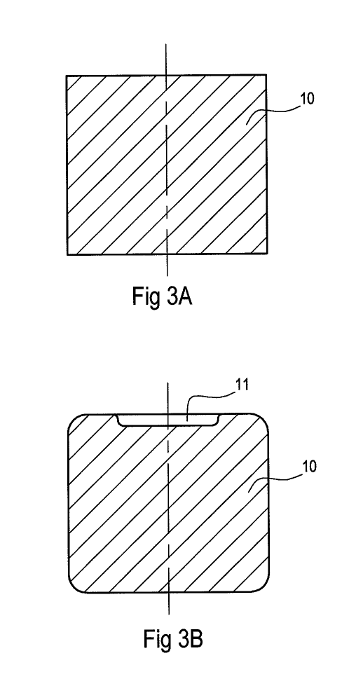

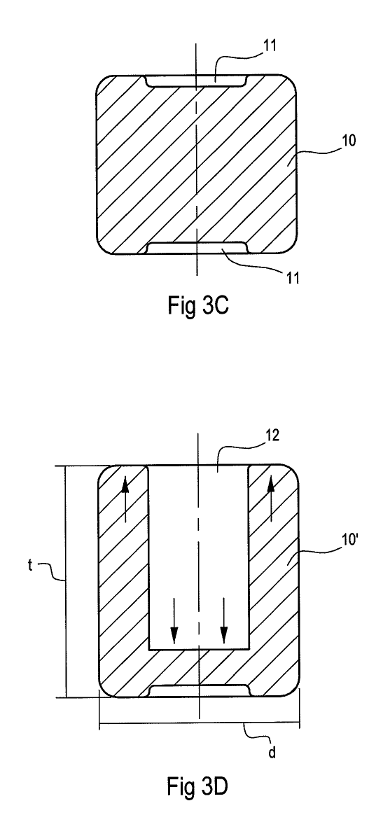

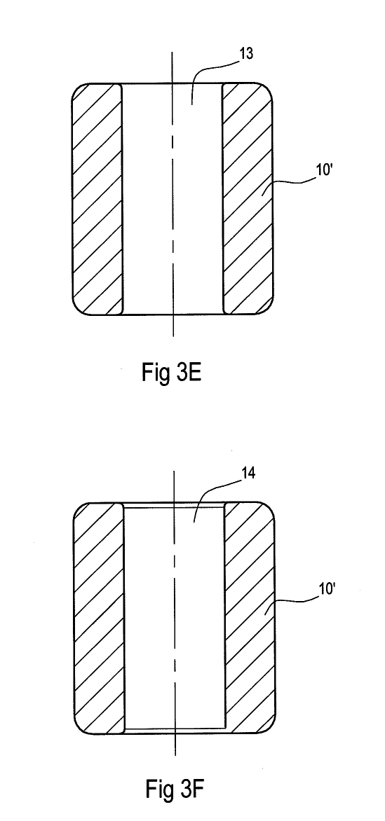

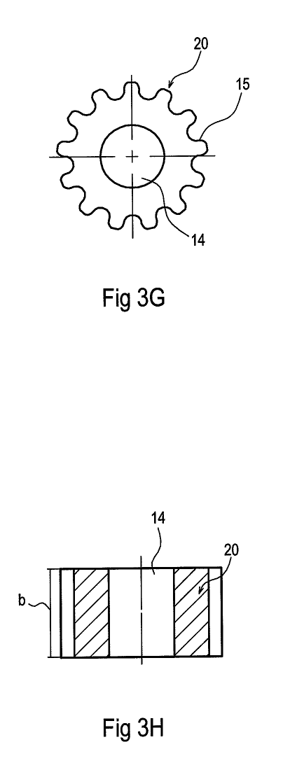

A billet 10 is obtained, and the billet 10 used in general forging of gears is rod-shaped metallic material, such as carbon steel, and the rod-shaped metallic material is cut to an appropriate length to serve as the billet 10 waiting to be machined (Step S100). Please also refer to FIG. 3A depicting a schematic structural view of a billet according to an embodiment of the present invention.

Two locating holes 11 are respectively sized in two end surfaces of the billet 10 where is vertical to axial direction of the billet 10 (Step S110), such that the billet 10 can be fixed in the correct position of a forming mold of the processing equipment. Referring to FIG. 3B and FIG. 3C, which show schematic structural views depicting the steps of sizing locating holes according to an embodiment of the present invention, and in the embodiment, the locating holes 11 are sized in the two end surfaces of the billet 10, but not limited to, and the locating holes 11 can be sized in only one end surface of the billet 10.

A mold (not shown in the drawings) is used to carry out a backward extrusion process of a billet 10 to form a forged billet 10′ with a blind hole 12 (Step S120). While the backward extrusion process is carried out, a restriction is imposed on forward of the billet 10 by the mold; therefore, the billet 10 is unable to flow forward. However, an open space is provided on backward of the billet 10, such that the billet 10 can flow to form the forged billet 10′ provided with an appropriate axial length t through the direction of the open space. On the other hand, because of the restriction of the mold, a radial length d of the forged billet 10′ obtains an appropriate degree of deformation, in which it is preferred that the following relationships exist between the radial length d and the axial length t of the forged billet 10′: t≦d≦3t. Please refer to FIG. 3D, which is a schematic structural view depicting implementation of the step of the backward extrusion process on a billet to form the forged billet 10′ according to an embodiment of the present invention.

A precise piercing process is carried out, in which a punching tool is used to remove the solid billet portion remained in the blind hole 12 of the forged billet 10′ to form a through hole 13 (Step S130). Please refer to FIG. 3E, which is a schematic structural view depicting implementation of the step of the precise piercing process according to an embodiment of the present invention.

It is preferred that at the same time or after the step of carrying out the precise piercing process, a more precise punching tool is used to trim the through hole 13 of the forged billet 10′ so as to form a high-precision inner hole 14 with a preferred real roundness and a surface roughness (Step S140). Please refer to FIG. 3F, which is a schematic structural view depicting the trimming of the through hole to form a high-precision inner hole according to an embodiment of the present invention.

A positioning process of the forged billet 10′ is carried out based on the through hole 13 or the high-precision inner hole 14, and then an outer tooth shape 15 of the forged billet 10′ is formed by a pressing process so as to form a gear (Step S150). The forged billet 10′ flows in a radial direction due to extrusion of the pressing mold in the pressing process and fills in the mold cavity of the pressing mold to form the outer tooth shape 15 of a gear 20, such that the relative precision of the final outer tooth shape 15 and the through hole 13 or the high-precision inner hole 14 can be ensured accordingly to enable inner hole precision when the gear is configured and the configuration precision when the gear is assembled to achieve a precision within the required tolerance. When the step of the pressing process is carried, the forged billet 10′ flows in a radial direction due to the extrusion of the pressing mold. Therefore, the axial length t of the forged billet 10′ is larger than a tooth face width b of the gear 20 after formation thereof, and the radial length d of the forged billet 10′ is smaller than the addendum circle diameter of the gear 20. Please refer to FIG. 3G which is a schematic structural view depicting implementation of a pressing process of an outer tooth shape of a billet according to an embodiment of the present invention, and FIG. 3H depicting a front cutaway view of FIG. 3G.

It is preferred that the method for forming a gear according to the present invention be used for micro-gears in which the modulus is less than or equal to 1, and the number of teeth is approximately between 12 and 20, and it is preferred that the aforementioned micro-gears are spur gears.

During the pre-forming process, the first five steps (Step S100 to Step S140) of the method for forming a gear of the present invention is enable to reduce the forming load of the pressing process of the sixth step (Step S150), so as to replace the hot forging heating process of the prior art and reduce work hardening. From the description of the aforementioned embodiments, it can be known that there is no need for heating by heating equipment during the gear forming process. Although some of forming methods adopt cold-hot forging in recent years, heating equipment is still required in the production process, and the effectiveness of cold forging finishing is still constrained by the quality of hot forging finishing. However, reviewing the method for forming a gear of the embodiments of the present invention, a difference between the conventional gear forming methods and the method of the present invention lies in that: the conventional methods first carry out upsetting, and then machining or cold forging for sizing the shape; however, one major characteristic of the present invention is that a backward extrusion forming technique is adopted, which has two purposes, first: a backward extrusion method is used to form the required length of a forged billet instead of using an upsetting method; second: a backward extrusion method is used to reduce the solid billet portion of the blind hole to a thickness which can be directly pierced out by the fourth step (Step S130), thereby facilitating finishing the inner hole of the fifth step (Step S140), and increasing the inner hole precision of the entire gear, as well as assisting positioning precision during final pressing process of the sixth step (Step S150).

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A method for forming a gear, the method comprising following steps of:
carrying out a backward extrusion process of a billet to form a forged billet with a blind hole by using a mold, wherein the forged billet is formed with an appropriate axial length and an appropriate radial length;
carrying out a precise piercing process of the forged billet to remove a solid billet portion remained in the blind hole of the forged billet so as to form a through hole; and
carrying out a positioning process of the forged billet based on the through hole, so as to implement a pressing process of an outer tooth shape of the forged billet, thereby forming the gear.

2. The method according to claim 1, wherein before the step of carrying out the backward extrusion process, the method further comprises sizing a locating hole in axial end surfaces vertical to the billet.

3. The method according to claim 1, wherein a thickness of the solid billet portion remained in the blind hole is less than or equal to a piercing thickness of the forged billet when carrying out the precise piercing process.

4. The method according to claim 1, wherein at same time or after the step of carrying out the precise piercing process, the method further comprises trimming of the through hole to form a high-precision inner hole.

5. The method according to claim 1, wherein the radial length of the forged billet is larger than or equal to the axial length, and is less than or equal to 3 times the axial length.

6. The method according to claim 1, wherein the gear is a micro-gear.

7. The method according to claim 6, wherein the micro-gear is a spur gear.

8. The method according to claim 7, wherein a modulus of the spur gear is less than or equal to 1.

9. The method according to claim 1, wherein the method is an exhaustive progressive cold forging method.

10. A gear, manufactured by the forming method according to claim 1, wherein the gear is a micro-gear.

11. The gear according to claim 10, wherein the micro-gear is a spur gear.

12. The gear according to claim 11, wherein the modulus of the spur gear is less than or equal to 1.
